(19) United States
(12) Patent Application Publication
(10) Pub. No.: US 2026/0269268 A1
(43) Pub. Date: Sep. 10, 2026

(54) SOLID-STATE BATTERY

(71) Applicant: FDK CORPORATION, Tokyo (JP)

(72) Inventors: Satoshi HIGUCHI, Tokyo (JP); Masakazu KOBAYASHI, Tokyo (JP); Minako SUZUKI, Tokyo (JP)

(73) Assignee: FDK CORPORATION, Tokyo (JP)

(21) Appl. No.: 19/164,895

(22) PCT Filed: Nov. 2, 2023
(86) PCT No.: PCT/JP2023/039599

§ 371 Date: Sep. 12, 2025

(30) Foreign Application Priority Data
Mar. 16, 2023 (JP) 2023-041805

(51) Int. Cl. H01M 4/62; H01M 10/0585; H01M 50/103; H01M 50/46

(52) U.S. Cl. CPC H01M 4/628; H01M 10/0585; H01M 50/103; H01M 50/46

(57) ABSTRACT

A solid-state battery having excellent reliability in which damage caused by expansion of a negative electrode layer during charging can be prevented is implemented. A solid-state battery includes a battery body. The battery body includes a stacked structure in which a positive electrode layer and a negative electrode layer are stacked in a first direction with an electrolyte layer interposed therebetween, and a cover layer configured to cover the stacked structure. In the battery body, an edge of the electrolyte layer in contact with the cover layer is located inward relative to an edge of the negative electrode layer in contact with the cover layer in a cross-sectional view along a second direction orthogonal to the first direction.

### TECHNICAL FIELD

The present invention relates to a solid-state battery.

### BACKGROUND ART

For example, there is known an all-solid-state battery including a positive electrode layer, a negative electrode layer, and a solid electrolyte layer provided between the positive electrode layer and the negative electrode layer, in which a width of the positive electrode layer is smaller than a width of the negative electrode layer and a width of the solid electrolyte layer, and a binder content of the solid electrolyte layer is larger in a non-facing portion where the solid electrolyte layer does not face the positive electrode layer than in a facing portion where the solid electrolyte layer faces the positive electrode layer (Patent Literature 1). Further, regarding this all-solid-state battery, a technique is known in which the width of the negative electrode layer is larger than the width of the solid electrolyte layer, and a binder content of the negative electrode layer is larger in a non-facing portion where the negative electrode layer does not face the solid electrolyte layer than in a facing portion where the negative electrode layer faces the solid electrolyte layer.

### CITATION LIST

### Patent Literature

Patent Literature 1: JP2020-129519A

### SUMMARY OF INVENTION

### Technical Problem

As a solid-state battery, a chargeable and dischargeable solid-state battery including a battery body is known. The battery body includes a stacked structure in which a positive electrode layer and a negative electrode layer are stacked with an electrolyte layer interposed therebetween and a cover layer that covers the stacked structure. In this solid-state battery, active material ions contained in the positive electrode layer are conducted to the negative electrode layer via the electrolyte layer during charging, and the active material ions conducted to the negative electrode layer are conducted to the positive electrode layer via the electrolyte layer during discharging. The negative electrode layer expands when the active material ions conducted from a positive electrode layer side are absorbed during charging of the solid-state battery. Therefore, in the solid-state battery, damage such as cracking or peeling may occur at an interface between the negative electrode layer or the like and the cover layer on an outer side of the negative electrode layer due to the expansion of the negative electrode layer during charging. Such damage may cause a decrease in strength, a decrease in moisture resistance, and the like of the solid-state battery, and may impair reliability of the solid-state battery.

According to one aspect, an object of the present invention is to implement a solid-state battery having excellent reliability in which damage caused by expansion of a negative electrode layer during charging can be prevented.

### Solution to Problem

According to one aspect, there is provided a solid-state battery including a battery body. The battery body includes a stacked structure in which a positive electrode layer and a negative electrode layer are stacked in a first direction with an electrolyte layer interposed therebetween, and a cover layer configured to cover the stacked structure. In the battery body, an edge of the electrolyte layer in contact with the cover layer is located inward relative to an edge of the negative electrode layer in contact with the cover layer in a cross-sectional view along a second direction orthogonal to the first direction.

### Advantageous Effects of Invention

According to one aspect, it is possible to implement a solid-state battery having excellent reliability in which damage caused by expansion of a negative electrode layer during charging can be prevented.

The object, features, and advantages of the present invention will become apparent from the following description taken in conjunction with the accompanying drawings illustrating preferred embodiments as examples of the present invention.

### BRIEF DESCRIPTION OF DRAWINGS

FIG. 1 is a diagram illustrating an example of a solid-state battery.

FIG. 2 is a diagram illustrating an example of a solid-state battery according to an embodiment.

FIG. 3 is a diagram illustrating a modification of the solid-state battery according to the embodiment.

FIG. 4 is a diagram (part 1) illustrating an example of a method for manufacturing the solid-state battery according to the embodiment.

FIG. 5 is a diagram (part 2) illustrating an example of a method for manufacturing the solid-state battery according to the embodiment.

(FIG. 6 is a diagram further illustrating a modification of the solid-state battery according to the embodiment.

### DESCRIPTION OF EMBODIMENTS

First, an example of a solid-state battery will be described.

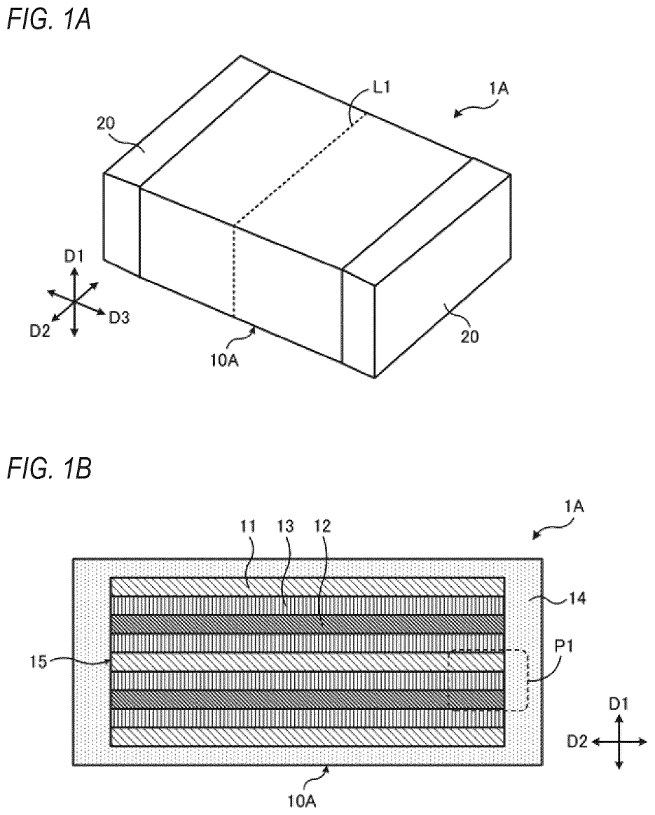

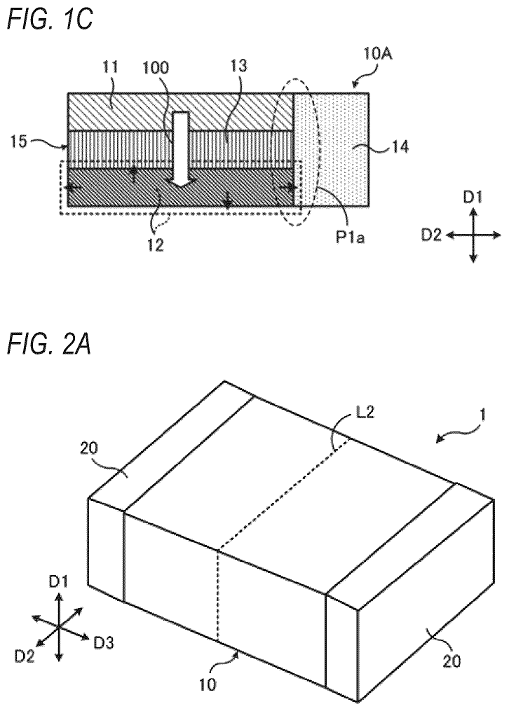

FIG. 1 is a diagram illustrating an example of the solid-state battery. (A) of FIG. 1 schematically illustrates a perspective view of a main part of the example of the solid-state battery. (B) and (C) of FIG. 1 each schematically illustrate a cross-sectional view of the main part of the example of the solid-state battery. (B) of FIG. 1 is a schematic cross-sectional view taken along a line LI in (A) of FIG. I. (C) of FIG. 1 is an enlarged view of a portion Pl in (B) of FIG. 1, schematically illustrating an example of a state during charging.

A solid-state battery 1A illustrated in (A) of FIG. 1 includes a battery body 10A and a pair of external connection terminals 20 provided at both end portions of the battery body 10A facing each other in a direction D3. The battery body 10A is also referred to as a “battery element”, a “battery element body”, or an “element body” of the solid-state battery 1A. Regarding the pair of external connection terminals 20 provided at both end portions of the battery body 10A, one functions as a positive electrode terminal of the solid-state battery 1A, and the other functions as a negative electrode terminal of the solid-state battery 1A.

In a cross-sectional view along a direction D2 orthogonal to the direction D3 in which the pair of external connection terminals 20 face each other, that is, in a cross-sectional view along the direction D2 as illustrated in (B) of FIG. 1, the battery body 10A includes a stacked structure 15 including positive electrode layers 11, negative electrode layers 12 each facing a positive electrode layer 11, and electrolyte layers 13 interposed therebetween. In the stacked structure 15, a plurality of positive electrode layers 11 and negative electrode layers 12 are stacked in a direction D1 such that the positive electrode layer 11 and the negative electrode layer 12 are alternately provided with the electrolyte layer 13 interposed therebetween. The direction D1, which is a stacking direction of the stacked structure 15, is a direction orthogonal to the direction D2 and the direction D3. In the battery body 10A of the solid-state battery 1A, the positive electrode layer 11, the negative electrode layer 12, and the electrolyte layer 13 have, for example, the same width in the direction D2. The battery body 10A further includes a cover layer 14 that covers a surface of the stacked structure 15 in which the positive electrode layer 11 and the negative electrode layer 12 are stacked with the electrolyte layer 13 interposed therebetween. One or both of the positive electrode layer 11 and the negative electrode layer 12 are also referred to as an “internal electrode layer”.

Although not illustrated here, in the battery body 10A, in a cross-sectional view along a direction in which the pair of external connection terminals 20 face each other, that is, in a cross-sectional view along the direction D3, the positive electrode layer 11 and the negative electrode layer 12 partially overlap each other with the electrolyte layer 13 interposed therebetween such that a part of a side surface of the positive electrode layer 11 is exposed from the cover layer 14 on one end portion side and a part of a side surface of the negative electrode layer 12 is exposed from the cover layer 14 on the other end portion side. The positive electrode layer 11 exposed on the one end portion side is connected to the one external connection terminal 20 functioning as the positive electrode terminal, and the negative electrode layer 12 exposed on the other end portion side is connected to the other external connection terminal 20 functioning as the negative electrode terminal.

The electrolyte layer 13 of the stacked structure 15 includes a solid electrolyte. For the solid electrolyte of the electrolyte layer 13, for example, an oxide solid electrolyte is used. For the oxide solid electrolyte of the electrolyte layer 13, for example, LAGP, which is a type of Na super ionic conductor (NASICON) type oxide solid electrolyte, is used. LAGP is an oxide solid electrolyte represented by a general formula Li₁₊ₓAlₓGe₂₋ₓ(PO₄)₃ (0<x≤1). In addition, a sulfide solid electrolyte such as lithium sulfide (Li₂S)-phosphorus pentasulfide (P₂S₅) may be used as the solid electrolyte of the electrolyte layer 13.

The positive electrode layer 11 of the stacked structure 15 contains a positive electrode active material, a conductive assistant, and a solid electrolyte. For the solid electrolyte of the positive electrode layer 11, an oxide solid electrolyte or a sulfide solid electrolyte, for example, the same material as the solid electrolyte used in the electrolyte layer 13 is used. For the positive electrode active material of the positive electrode layer 11, lithium cobalt pyrophosphate (Li₂CoP₂O₇, hereinafter, also referred to as “LCPO”) is used. For the conductive assistant of the positive electrode layer 11, a carbon material such as carbon fiber, carbon black, graphite, graphene, or carbon nanotubes, or a conductive material such as iron silicide, is used, for example.

The negative electrode layer 12 of the stacked structure 15 contains a negative electrode active material, a conductive assistant, and a solid electrolyte. For the solid electrolyte of the negative electrode layer 12, an oxide solid electrolyte or a sulfide solid electrolyte, for example, the same material as the solid electrolyte used in the electrolyte layer 13 is used. For the negative electrode active material of the negative electrode layer 12, for example, titanium oxide (TiO₂), niobium pentoxide (Nb₂O₅), or the like is used. In addition, for the negative electrode active material of the negative electrode layer 12, lithium vanadium phosphate (Li: V₂(PO₄)₃), lithium titanate (Li₄Ti₅O₁₂), or the like may be used. For the conductive assistant of the negative electrode layer 12, a carbon material such as carbon fiber, carbon black, graphite, graphene, or carbon nanotubes, or a conductive material such as iron silicide, is used, for example.

The solid-state battery 1A is an example of a chargeable and dischargeable solid-state battery, that is, an example of a secondary battery or a solid-state secondary battery. In the solid-state battery 1A, lithium ions are conducted from the positive electrode layer 11 to the negative electrode layer 12 via the electrolyte layer 13 and are absorbed during charging, and the lithium ions are conducted from the negative electrode layer 12 to the positive electrode layer 11 via the electrolyte layer 13 and are absorbed during discharging. In the solid-state battery 1A, charging and discharging operations are implemented by such lithium ion conduction in the stacked structure 15 of the battery body 10A.

For the cover layer 14 that covers the stacked structure 15, for example, an insulating material having a higher hardness than the solid electrolyte is used. As an example, for the cover layer 14, an insulating material having a higher hardness than the solid electrolyte used in the electrolyte layer 13 is used. Alternatively, for the cover layer 14, an insulating material having a higher hardness than the solid electrolyte used in the electrolyte layer 13 and the solid electrolyte used in the positive electrode layer 11 and the negative electrode layer 12, which are the internal electrode layers, is used. An insulating property of the cover layer 14 refers to a property that has no or a sufficiently low effect on the lithium ion conduction and electron conduction in the battery body 10A. For the insulating cover layer 14 having a higher hardness than the solid electrolyte, for example, glass or ceramic is used.

The cover layer 14 has a function of protecting the stacked structure 15 from an external force and outside air. Therefore, as the cover layer 14, a cover layer is used that has the hardness and the insulating property as described above, has low permeability to moisture or gas such as hydrogen or oxygen, and can implement good sealability. Among materials that can be used for the cover layer 14, glass or ceramic is one type of material that can have these properties, and is suitable as a material for forming the cover layer 14. In addition to glass or ceramic, the solid electrolyte may be used for the cover layer 14.

In the solid-state battery 1A having the above-described configuration, the lithium ions, which are active material ions contained in the positive electrode layer 11, are conducted to the negative electrode layer 12 via the electrolyte layer 13 during charging, and the lithium ions, which are the active material ions conducted to the negative electrode layer 12, are conducted to the positive electrode layer 11 via the electrolyte layer 13 during discharging. The negative electrode layer 12 expands when the lithium ions conducted from a positive electrode layer 11 side are absorbed during charging, and contracts when the lithium ions to be conducted to a positive electrode layer 11 side are released during discharging. As described above, in the solid-state battery 1A, the negative electrode layer 12 expands and contracts with charging and discharging.

For example, as illustrated in (C) of FIG. 1, when lithium ion conduction 100 occurs from the positive electrode layer 11 to the negative electrode layer 12 via the electrolyte layer 13 and the lithium ions are absorbed into the negative electrode layer 12 during charging of the solid-state battery 1A, a volume of the negative electrode layer 12 increases by an amount of the absorbed lithium ions. That is, as schematically illustrated by dotted lines and arrows in (C) of FIG. 1, the negative electrode layer 12 expands.

Stress is generated inside the solid-state battery 1A due to such expansion of the negative electrode layer 12. When a plurality of negative electrode layers 12 are provided, the stress is added up by the number of negative electrode layers 12. Therefore, relatively large stress may be generated inside the solid-state battery 1A. In a case of the solid-state battery 1A that is repeatedly charged and discharged, the negative electrode layer 12 also repeatedly expands and contracts, and such stress may be generated every time the negative electrode layer 12 expands.

Here, for the cover layer 14 outside the negative electrode layer 12, a material such as glass or ceramic that is less likely to expand or deform than the negative electrode layer 12 may be used. In this case, the cover layer 14 outside the negative electrode layer 12 cannot deform in response to the expansion of the negative electrode layer 12 during charging, and damage such as cracking or peeling may occur in a portion such as a portion P1a illustrated in (C) of FIG. 1, that is, a portion where the cover layer 14 and the negative electrode layer 12 are in contact with each other, or a portion where the cover layer 14 and the electrolyte layer 13 or the positive electrode layer 11 are in contact with each other. The damage such as the cracking may propagate to an outer surface of the solid-state battery 1A (the cover layer 14 thereof) from these portions. Such damage occurring in the solid-state battery 1A may cause a decrease in strength, a decrease in moisture resistance, and the like of the solid-state battery 1A, and may impair reliability of the solid-state battery 1A.

In view of the above-described points, a solid-state battery having excellent reliability in which damage caused by expansion of a negative electrode layer during charging can be prevented is implemented by adopting a configuration described below as an embodiment.

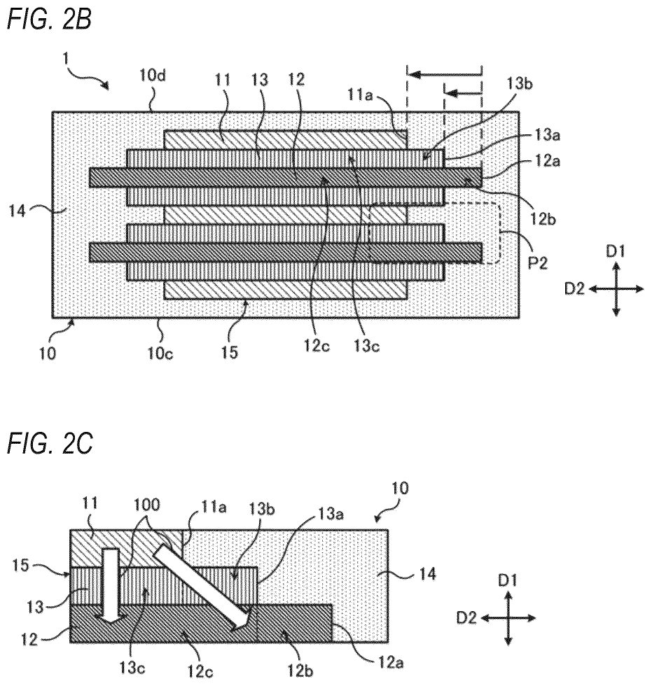

FIG. 2 is a diagram illustrating an example of a solid-state battery according to the embodiment. (A) of FIG. 2 schematically illustrates a perspective view of a main part of the example of the solid-state battery. (B) and (C) of FIG. 2 each schematically illustrate a cross-sectional view of the main part of the example of the solid-state battery. (B) of FIG. 2 is a schematic cross-sectional view taken along a line L2 in (A) of FIG. 2. (C) of FIG. 2 is an enlarged view of a portion P2 in (B) of FIG. 2, schematically illustrating an example of a state during charging.

A solid-state battery 1 illustrated in (A) of FIG. 2 includes a battery body 10 and the pair of external connection terminals 20 provided at both end portions of the battery body 10 facing each other in the direction D3. Regarding the pair of external connection terminals 20, one functions as a positive electrode terminal of the solid-state battery 1, and the other functions as a negative electrode terminal of the solid-state battery 1.

In a cross-sectional view along the direction D2 orthogonal to the direction D3 in which the pair of external connection terminals 20 face each other, that is, in a cross-sectional view along the direction D2 as illustrated in (B) of FIG. 2, the battery body 10 includes the stacked structure 15 including the positive electrode layers 11, the negative electrode layers 12 each facing a positive electrode layer 11, and the electrolyte layers 13 interposed therebetween. In the stacked structure 15, a plurality of positive electrode layers 11 and negative electrode layers 12 are stacked in the direction D1 such that the positive electrode layer 11 and the negative electrode layer 12 are alternately provided with the electrolyte layer 13 interposed therebetween. For example, in the battery body 10, the positive electrode layers 11, the negative electrode layers 12, and the electrolyte layers 13 are stacked such that both a lowermost layer and an uppermost layer in the stacked structure 15 including the positive electrode layers 11, the negative electrode layers 12, and the electrolyte layers 13 stacked in the direction D1 are the positive electrode layers 11. The direction D1, which is a stacking direction of the stacked structure 15, is a direction orthogonal to the direction D2 and the direction D3. The battery body 10 further includes a cover layer 14 that covers a surface of the stacked structure 15 in which the positive electrode layer 11 and the negative electrode layer 12 are stacked with the electrolyte layer 13 interposed therebetween.

Although not illustrated here, in the battery body 10, in a cross-sectional view along a direction in which the pair of external connection terminals 20 face each other, that is, in a cross-sectional view along the direction D3, the positive electrode layer 11 and the negative electrode layer 12 partially overlap each other with the electrolyte layer 13 interposed therebetween such that a part of a side surface of the positive electrode layer 11 is exposed from the cover layer 14 on one end portion side and a part of a side surface of the negative electrode layer 12 is exposed from the cover layer 14 on the other end portion side. The positive electrode layer 11 exposed on the one end portion side is connected to the one external connection terminal 20 functioning as the positive electrode terminal, and the negative electrode layer 12 exposed on the other end portion side is connected to the other external connection terminal 20 functioning as the negative electrode terminal The same materials as the positive electrode layer 11, the negative electrode layer 12, the electrolyte layer 13, and the cover layer 14 described for the battery body 10A of the solid-state battery 1A ((A) and (B) of FIG. 1, etc.) are used for the positive electrode layer 11, the negative electrode layer 12, the electrolyte layer 13, and the cover layer 14 provided in the battery body 10 of the solid-state battery 1 ((A) and (B) of FIG. 2, etc.) according to this embodiment.

The solid-state battery 1 is an example of the chargeable and dischargeable solid-state battery. In the solid-state battery 1, lithium ions are conducted from the positive electrode layer 11 to the negative electrode layer 12 via the electrolyte layer 13 and are absorbed during charging, and the lithium ions are conducted from the negative electrode layer 12 to the positive electrode layer 11 via the electrolyte layer 13 and are absorbed during discharging. In the solid-state battery 1, charging and discharging operations are implemented by such lithium ion conduction in the stacked structure 15 of the battery body 10.

In the solid-state battery 1, in the cross-sectional view along the direction D2 as illustrated in (B) of FIG. 2, the electrolyte layer 13 is provided inward relative to the negative electrode layer 12, and the positive electrode layer 11 is provided inward relative to the negative electrode layer 12 and the electrolyte layer 13. That is, in the direction D2, an edge 13a of the electrolyte layer 13 in contact with the cover layer 14 is located inward relative to an edge 12a of the negative electrode layer 12 in contact with the cover layer 14 (indicated by an arrow in (B) of FIG. 2). An edge 11a of the positive electrode layer 11 in contact with the cover layer 14 is located inward relative to the edge 12a of the negative electrode layer 12 in contact with the cover layer 14 (indicated by an arrow in (B) of FIG. 2), and is located inward relative to the edge 13a of the electrolyte layer 13 in contact with the cover layer 14. As an example, the electrolyte layer 13 is provided inward relative to the negative electrode layer 12 in a range of 1% to 10% with respect to an entire width of the negative electrode layer 12 in the direction D2. As an example, the positive electrode layer 11 is provided inward relative to the electrolyte layer 13 in a range of 1% to 10% with respect to the entire width of the negative electrode layer 12 in the direction D2.

In the solid-state battery 1, since the electrolyte layer 13 is provided inward relative to the negative electrode layer 12, and the positive electrode layer 11 is provided inward relative to the negative electrode layer 12 and the electrolyte layer 13, damage caused by expansion of the negative electrode layer 12 during charging is prevented.

For example, as illustrated in (C) of FIG. 2, during charging of the solid-state battery 1, the lithium ion conduction 100 occurs from the positive electrode layer 11 to the negative electrode layer 12 via the electrolyte layer 13, and the lithium ions are absorbed into the negative electrode layer 12.

Here, in the solid-state battery 1, the electrolyte layer 13 serving as a conduction path of the lithium ions is provided inward relative to the negative electrode layer 12. Therefore, during charging of the solid-state battery 1, an amount of lithium ions absorbed into a non-facing portion 12b where the negative electrode layer 12 does not face the electrolyte layer 13 is smaller than an amount of lithium ions absorbed into a facing portion 12c where the negative electrode layer 12 faces the electrolyte layer 13. That is, a utilization rate of the non-facing portion 12b of the negative electrode layer 12 during charging is reduced.

In addition, in the solid-state battery 1, the positive electrode layer 11 that releases the lithium ions during charging is provided inward relative to the electrolyte layer 13. Therefore, during charging of the solid-state battery 1, an amount of lithium ions conducted through a non-facing portion 13b where the electrolyte layer 13 does not face the positive electrode layer 11 is smaller than an amount of lithium ions conducted through a facing portion 13c where the electrolyte layer 13 faces the positive electrode layer 11. Therefore, the amount of lithium ions absorbed into the non-facing portion 12b of the negative electrode layer 12 located further outward relative to the non-facing portion 13b of the electrolyte layer 13 is further prevented. Accordingly, the utilization rate of the non-facing portion 12b of the negative electrode layer 12 during charging is further reduced.

As described above, in the solid-state battery 1, the amount of lithium ions absorbed into the non-facing portion 12b of the negative electrode layer 12 is prevented during charging, and the utilization rate of the non-facing portion 12b is reduced. Therefore, expansion of the non-facing portion 12b of the negative electrode layer 12 is prevented during charging. In the solid-state battery 1, since the expansion of the non-facing portion 12b of the negative electrode layer 12 is prevented during charging, stress generated due to the expansion is prevented. Accordingly, in the solid-state battery 1, even when a material such as glass or ceramic that is less likely to deform for the cover layer 14, damage such as cracking or peeling is prevented in a portion where the cover layer 14 and the negative electrode layer 12 (the non-facing portion 12b thereof) are in contact with each other or a portion where the cover layer 14 and the electrolyte layer 13 or the positive electrode layer 11 are in contact with each other. By preventing the occurrence of damage, a decrease in strength, a decrease in moisture resistance, and the like of the solid-state battery 1 are prevented, and the solid-state battery I having excellent reliability is implemented.

For example, in the solid-state battery 1, the positive electrode layers 11, the negative electrode layers 12, and the electrolyte layers 13 are stacked such that both a lowermost layer and an uppermost layer in the stacked structure 15 including the positive electrode layers 11, the negative electrode layers 12, and the electrolyte layers 13 stacked in the direction D1 are the positive electrode layers 11. Accordingly, the negative electrode layer 12 that expands when the lithium ions are absorbed during charging is separated from a lower surface 10c and an upper surface 10d of the cover layer 14 that form an outer surface of the solid-state battery 1. Therefore, even when the damage such as cracking occurs in the cover layer 14 due to the expansion of the negative electrode layer 12, it is possible to prevent the damage from progressing to the lower surface 10c or the upper surface 10d of the cover layer 14 and to prevent the formation of an infiltration path of moisture or the like.

The configuration of the solid-state battery capable of preventing the damage caused by the expansion of the negative electrode layer 12 during charging is not limited to that of the solid-state battery 1.

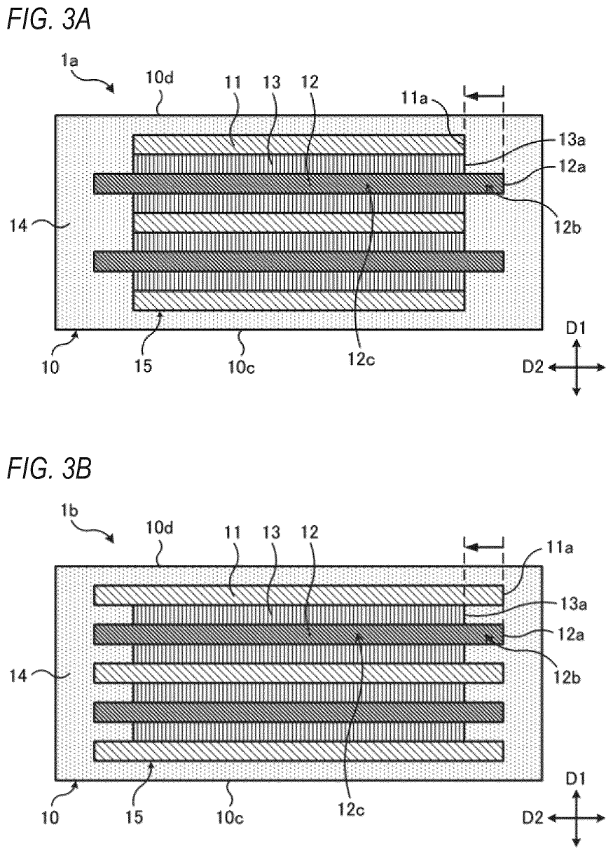

FIG. 3 is a diagram illustrating modifications of the solid-state battery according to the embodiment. (A) and (B) of FIG. 3 each schematically illustrate a cross-sectional view of a main part of an example of a solid-state battery. (A) and (B) of FIG. 3 are each a schematic cross-sectional view of the modification at a position along the line L2 in (A) of FIG. 2.

A solid-state battery 1a illustrated in (A) of FIG. 3 includes the battery body 10 in which the electrolyte layer 13 and the positive electrode layer 11 are provided inward relative to the negative electrode layer 12 of the stacked structure 15 in a cross-sectional view along the direction D2. That is, the solid-state battery 1a has a configuration in which the edge 13a of the electrolyte layer 13 and the edge 11a of the positive electrode layer 11 are located inward relative to the edge 12a of the negative electrode layer 12 in the direction D2. In the solid-state battery 1a, a width of the positive electrode layer 11 in the direction D2 is equal to a width of the electrolyte layer 13 in the direction D2. The solid-state battery 1a is different from the solid-state battery 1 ((A) and (B) of FIG. 2, and the like) in that the solid-state battery 1a has such a configuration.

In the solid-state battery 1a as illustrated in (A) of FIG. 3, the electrolyte layer 13 is provided inward relative to the negative electrode layer 12, so that an amount of lithium ions absorbed into the non-facing portion 12b where the negative electrode layer 12 does not face the electrolyte layer 13 is also smaller than an amount of lithium ions absorbed into the facing portion 12c where the negative electrode layer 12 faces the electrolyte layer 13. That is, a utilization rate of the non-facing portion 12b of the negative electrode layer 12 during charging is reduced. Accordingly, expansion of the non-facing portion 12b of the negative electrode layer 12 is prevented during charging, and damage such as cracking or peeling is prevented in a portion where the cover layer 14 and the negative electrode layer 12 are in contact with each other or a portion where the cover layer 14 and the electrolyte layer 13 or the positive electrode layer 11 are in contact with each other. Therefore, the solid-state battery 1a having excellent reliability in which a decrease in strength, a decrease in moisture resistance, and the like caused by the damage are prevented is implemented.

The solid-state battery 1b illustrated in (B) of FIG. 3 includes the battery body 10 in which the electrolyte layer 13 is provided inward relative to the negative electrode layer 12 and the positive electrode layer 11 of the stacked structure 15 in a cross-sectional view along the direction D2. That is, the solid-state battery 1b has a configuration in which the edge 13a of the electrolyte layer 13 is located inward relative to the edge 12a of the negative electrode layer 12 and the edge 11a of the positive electrode layer 11 in the direction D2. In the solid-state battery 1b, a width of the positive electrode layer 11 in the direction D2 is larger than a width of the electrolyte layer 13 in the direction D2, and is, for example, equal to a width of the negative electrode layer 12 in the direction D2. The solid-state battery 1b is different from the solid-state battery 1 ((A) and (B) of FIG. 2, and the like) in that the solid-state battery 1b has such a configuration.

In the solid-state battery 1b as illustrated in (B) of FIG. 3, the electrolyte layer 13 is provided inward relative to the negative electrode layer 12, so that an amount of lithium ions absorbed into the non-facing portion 12b where the negative electrode layer 12 faces the electrolyte layer 13 is prevented during charging, and a utilization rate of the non-facing portion 12b is reduced. Accordingly, expansion of the non-facing portion 12b of the negative electrode layer 12 is prevented during charging, and damage such as cracking or peeling is prevented in a portion where the cover layer 14 is in contact with the negative electrode layer 12 or further the electrolyte layer 13 or the positive electrode layer 11. Therefore, the solid-state battery 1b having excellent reliability in which a decrease in strength, a decrease in moisture resistance, and the like caused by the damage are prevented is implemented.

As the battery body 10, in addition to the battery body 10 provided in the solid-state battery 1 ((B) of FIG. 2), the battery body 10 provided in the solid-state battery 1a ((A) of FIG. 3) or the solid-state battery 1b ((B) of FIG. 3) may be adopted.

Next, a method for manufacturing a solid-state battery will be described.

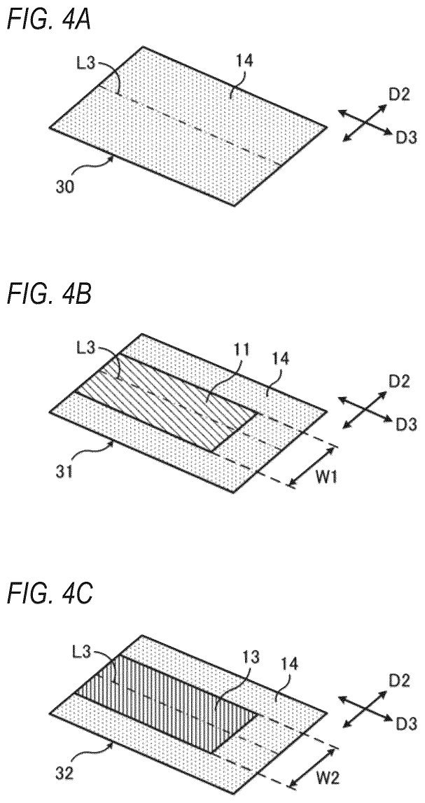

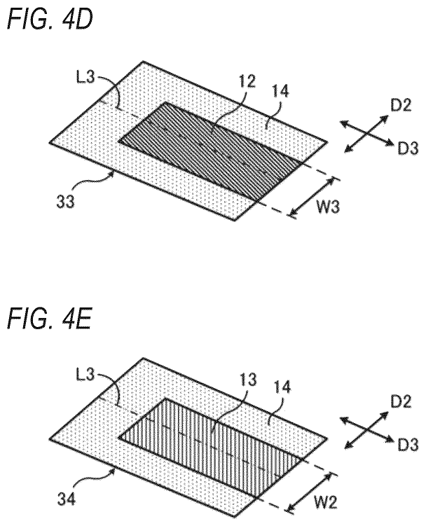

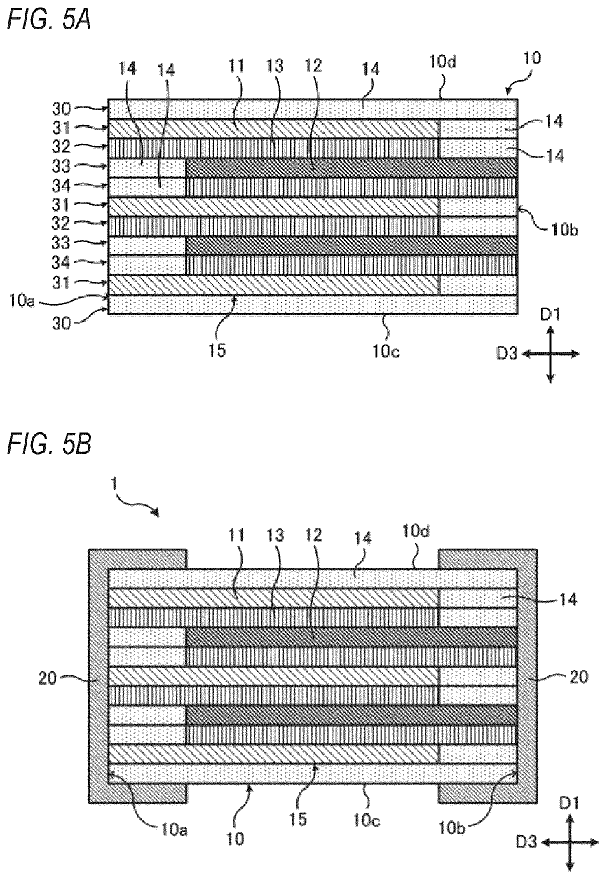

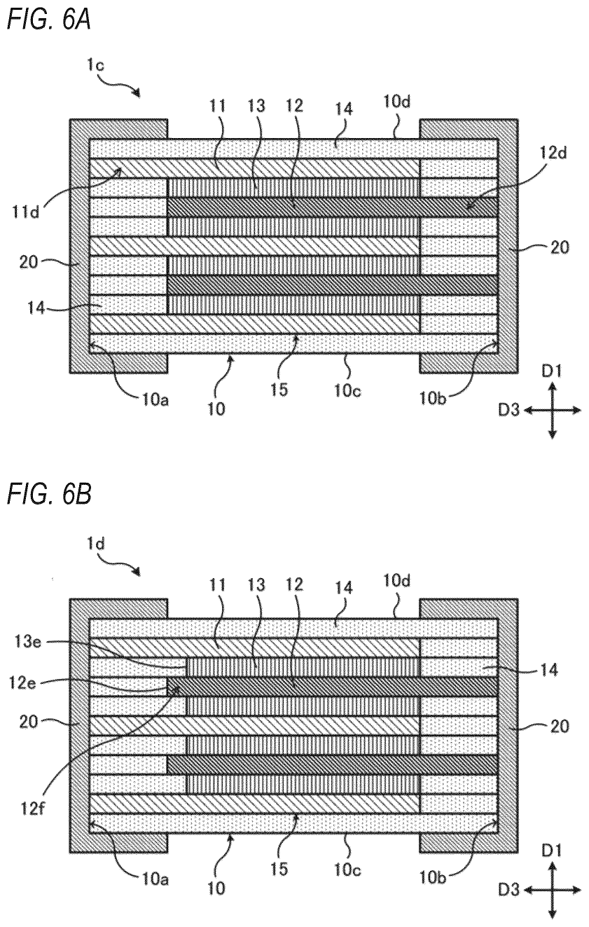

FIGS. 4 and 5 are each a diagram illustrating an example of the method for manufacturing the solid-state battery according to the embodiment. (A), (B), (C), (D), and (E) of FIG. 4 each schematically illustrate a perspective view of a main part of an example of a step of forming a layer part constituting the solid-state battery. (A) of FIG. 5 schematically illustrates a cross-sectional view of a main part of an example of a step of stacking the layer parts. (B) of FIG. 5 schematically illustrates a cross-sectional view of a main part of an example of a step of forming an external connection terminal.

When manufacturing the above-described solid-state battery 1, solid-state battery 1a, or solid-state battery 1b, for example, the layer parts as illustrated in (A) to (E) of FIG. 4 are formed.

When forming each layer part, a paste for the electrolyte layer 13, a paste for the positive electrode layer 11, a paste for the negative electrode layer 12, and a paste for the cover layer 14 are prepared. As the paste for the positive electrode layer 11, a paste containing a positive electrode active material, a solid electrolyte, a conductive assistant, a binder, a plasticizer, a dispersant, and a diluent is prepared. As the paste for the negative electrode layer 12, a paste containing a negative electrode active material, a solid electrolyte, a conductive assistant, a binder, a plasticizer, a dispersant, and a diluent is prepared. As the paste for the electrolyte layer 13, a paste containing a binder, a plasticizer, a dispersant, and a diluent in addition to a solid electrolyte is prepared. As the paste for the cover layer 14, for example, a paste containing a binder, a plasticizer, a dispersant, and a diluent in addition to glass, ceramic, or a solid electrolyte is prepared.

The paste for the cover layer 14 is applied onto a support such as a polyethylene terephthalate (PET) film and dried to form a layer part 30, that is, the layer part 30 serving as the cover layer 14 as illustrated in (A) of FIG. 4.

The paste for the positive electrode layer 11 and the paste for the cover layer 14 provided on an outer side of the paste for the positive electrode layer 11 are applied onto a support and dried to form a layer part 31, that is, the layer part 31 including the positive electrode layer 11 and the cover layer 14 on an outer side of the positive electrode layer 11 as illustrated in (B) of FIG. 4.

The paste for the electrolyte layer 13 and the paste for the cover layer 14 provided on an outer side of the paste for the positive electrode layer 13 are applied onto a support and dried to form a layer part 32, that is, the layer part 32 including the electrolyte layer 13 and the cover layer 14 on an outer side of the electrolyte layer 13 as illustrated in (C) of FIG. 4.

The paste for the negative electrode layer 12 and the paste for the cover layer 14 provided on an outer side of the paste for the negative electrode layer 12 are applied onto a support and dried to form a layer part 33, that is, the layer part 33 including the negative electrode layer 12 and the cover layer 14 on an outer side of the negative electrode layer 12 as illustrated in (D) of FIG. 4.

The paste for the electrolyte layer 13 and the paste for the cover layer 14 provided on an outer side of the paste for the positive electrode layer 13 are applied onto a support and dried to form a layer part 34, that is, the layer part 34 including the electrolyte layer 13 and the cover layer 14 on the outer side of the electrolyte layer 13 as illustrated in (D) of FIG. 4.

The direction D2 and the direction D3 illustrated in (A) to (E) of FIG. 4 are each a direction orthogonal to the direction D1 in which the layer parts 30 to 34 are stacked in a predetermined stacking order as described later. The direction D3 is a direction in which the pair of external connection terminals 20 formed as described later face each other, and the direction D2 is a direction orthogonal to the direction D3.

Here, a width W1 of the positive electrode layer 11 in the direction D2 in the layer part 31, a width W2 of the electrolyte layer 13 in the direction D2 in the layer part 32 and the layer part 34, and a width W3 of the negative electrode layer 12 in the direction D2 in the layer part 33 are appropriately adjusted according to the configuration of the battery body 10 of the solid-state battery 1, the solid-state battery 1a, or the solid-state battery 1b to be manufactured.

For example, in a case of the solid-state battery 1 ((B) of FIG. 2), the width W2 of the electrolyte layer 13 in the layer part 32 and the layer part 34 is adjusted to be smaller than the width W3 of the negative electrode layer 12 in the layer part 33, and the width W1 of the positive electrode layer 11 in the layer part 31 is adjusted to be smaller than the width W2 of the electrolyte layer 13 in the layer part 32 and the layer part 34. In addition, in a case of the solid-state battery 1a ((A) of FIG. 3), the width W1 of the positive electrode layer 11 in the layer part 31 and the width W2 of the electrolyte layer 13 in the layer part 32 and the layer part 34 are adjusted to be smaller than the width W3 of the negative electrode layer 12 in the layer part 33. In a case of the solid-state battery 1b ((B) of FIG. 3), the width W2 of the electrolyte layer 13 in the layer part 32 and the layer part 34 is adjusted to be smaller than the width W1 of the positive electrode layer 11 in the layer part 31 and the width W3 of the negative electrode layer 12 in the layer part 33.

(C) and (E) of FIG. 4 respectively illustrate the layer part 32 and the layer part 34. The layer part 32 and the layer part 34 each include the electrolyte layer 13 having a shape reaching one end side and not reaching the other end side in the direction D3 and the cover layer 14 provided on the outer side of the electrolyte layer 13. In addition, the layer part 32 and the layer part 34 may each include the electrolyte layer 13 having a shape (also referred to as a “floating island shape”) not reaching both one end side and the other end side in the direction D3 and the cover layer 14 provided to surround an outer periphery of the electrolyte layer 13 having such a floating island shape. Further, the layer part 32 and the layer part 34 may each include the electrolyte layer 13 having a shape (also referred to as a “penetrating shape”) reaching both one end side and the other end side in the direction D3 and includes the cover layer 14 provided to sandwich the electrolyte layer 13 having such a penetrating shape from both sides in the direction D2. Forms of the layer part 32 and the layer part 34 can be appropriately changed according to the configuration of the solid-state battery using the layer part 32 and the layer part 34.

The formed layer parts 30 to 34 are stacked in the direction D1, that is, the direction D1 orthogonal to the direction D2 and the direction D3 in the predetermined stacking order as illustrated in (A) of FIG. 5, and are thermocompression-bonded under predetermined temperature and pressure conditions. Accordingly, the battery body 10, which includes the stacked structure 15 in which the positive electrode layer 11 and the negative electrode layer 12 are stacked with the electrolyte layer 13 interposed therebetween and the cover layer 14 that covers the stacked structure 15, is formed. (A) and (B) of FIG. 5 each schematically illustrate a cross section of the layer parts 30 to 34 illustrated in (A) to (E) of FIG. 4 corresponding to a position of a line L3 (center line) along the direction D3. Regarding an end surface 10a and an end surface 10b of the battery body 10 facing each other in the direction D3, a part of the side surface of the positive electrode layer 11 is exposed at one end surface 10a, and a part of the side surface of the negative electrode layer 12 is exposed at the other end surface 10b. The end surface 10a in which the positive electrode layer 11 is exposed is also referred to as a “positive electrode lead-out surface” or a “first end surface”. The end surface 10b in which the negative electrode layer 12 is exposed is also referred to as a “negative electrode lead-out surface” or a “second end surface”. One or both of the positive electrode lead-out surface and the negative electrode lead-out surface are also referred to as an “electrode lead-out surface”.

The battery body 10 may have a structure as illustrated in (A) of FIG. S, that is, a structure, in which the positive electrode layer 11 is exposed on the one end surface 10a and the negative electrode layer 12 is exposed on the other end surface 10b, obtained by performing cutting after stacking and thermocompression bonding. In this case, the layer parts 31 to 34 are not limited to the form illustrated in (B) to (E) of FIG. 4, and may each have a form in which the cover layer 14 is provided to surround entire peripheries of the positive electrode layer 11, the electrolyte layer 13, and the negative electrode layer 12, or may have a structure illustrated in (A) of FIG. 5 obtained by cutting the layer parts after the stacking and thermocompression bonding.

Regarding the battery body 10 after the stacking and thermocompression bonding (after further cutting when cutting is performed), an organic component such as a binder is degreased by a heat treatment under a predetermined condition, and further, the solid electrolyte or the like contained therein is fired by a heat treatment under a predetermined condition. Accordingly, the battery body 10 of the solid-state battery 1, the solid-state battery 1a, or the solid-state battery 1b is completed.

As illustrated in (B) of FIG. 5, the external connection terminals 20 are formed on an end surface 10a (positive electrode lead-out surface) side and an end surface 10b (negative electrode lead-out surface) side of the battery body 10, respectively. For example, the external connection terminals 20 are formed by applying a paste containing a conductive material such as silver (Ag) to the end surface 10a side and the end surface 10b side of the battery body 10, baking or curing the paste by a heat treatment under a predetermined condition, and plating the surface with nickel (Ni) and tin (Sn). The positive electrode layer 11 exposed on the end surface 10a of the battery body 10 is connected to the external connection terminal 20 formed on the end surface 10a side, and the negative electrode layer 12 exposed on the end surface 10b of the battery body 10 is connected to the external connection terminal 20 formed on the end surface 10b side. The external connection terminal 20 connected to the positive electrode layer 11 functions as a positive electrode terminal of the solid-state battery 1, the solid-state battery 1a, or the solid-state battery 1b, and the external connection terminal 20 connected to the negative electrode layer 12 functions as a negative electrode terminal of the solid-state battery 1, the solid-state battery 1a, or the solid-state battery 1b.

Through the above-described steps, the solid-state battery 1, the solid-state battery 1a, or the solid-state battery 1b is manufactured. In (B) of FIG. 5, for convenience, the solid-state battery 1 is illustrated as a representative example of the solid-state battery 1, the solid-state battery 1a, and the solid-state battery 1b, but the solid-state battery 1a and the solid-state battery 1b are also manufactured in a configuration as illustrated in (B) of FIG. 5 in a cross-sectional view along the direction D3.

FIG. 6 is a diagram further illustrating a modification of the solid-state battery according to the embodiment. (A) and (B) of FIG. 6 each schematically illustrate a cross-sectional view of a main part of an example of a solid-state battery.

A solid-state battery 1c illustrated in (A) of FIG. 6 is different from the solid-state battery 1 illustrated in (B) of FIG. 5 (and the solid-state battery 1a and the solid-state battery 1b) in that the electrolyte layer 13 is provided in a region where the positive electrode layer 11 and the negative electrode layer 12 face each other in a cross-sectional view along the direction D3 in which the pair of external connection terminals 20 face each other.

In the solid-state battery 1c, the electrolyte layer 13 is not provided at an end portion of the negative electrode layer 12 on a side connected to the external connection terminal 20, that is, a non-facing portion 12d where the negative electrode layer 12 does not face the positive electrode layer 11. Therefore, among lithium ions conducted from the positive electrode layer 11 to the negative electrode layer 12 via the electrolyte layer 13 during charging, an amount of lithium ions absorbed into the non-facing portion 12d of the negative electrode layer 12 is prevented, and a utilization rate of the non-facing portion 12d is reduced. Accordingly, expansion of the non-facing portion 12d of the negative electrode layer 12 is prevented during charging, and damage such as cracking or peeling is prevented in a portion where the cover layer 14 is in contact with the negative electrode layer 12 or further the electrolyte layer 13 or the positive electrode layer 11. In addition, the expansion of the non-facing portion 12d of the negative electrode layer 12 is prevented during charging, so that occurrence of damage such as cracking or disconnection in a connection portion between the negative electrode layer 12 and the external connection terminal 20 is prevented.

Further, in the solid-state battery 1c, when a relatively hard material such as glass or ceramic is used for the cover layer 14, a space between the non-facing portions 12d of a group of negative electrode layers 12 in different layers and a space between the non-facing portions 11d of a group of positive electrode layers 11 in different layers are filled with the relatively hard cover layer 14. Accordingly, strength of the solid-state battery 1c is improved.

With the configuration as illustrated in (A) of FIG. 6, the solid-state battery 1c having excellent reliability is implemented.

A solid-state battery 1d illustrated in (B) of FIG. 6 is different from the solid-state battery 1c illustrated in (A) of FIG. 6 in that an edge 13e of the electrolyte layer 13 provided in a region where the positive electrode layer 11 and the negative electrode layer 12 face each other is located inward relative to an edge 12e of the negative electrode layer 12 in a cross-sectional view along the direction D3 in which the pair of external connection terminals 20 face each other.

In the solid-state battery 1d, the same effects as those described for the solid-state battery 1c can be obtained. Therefore, in the solid-state battery 1d, among lithium ions conducted from the positive electrode layer 11 to the negative electrode layer 12 via the electrolyte layer 13 during charging, an amount of lithium ions absorbed into an end portion 12f on an edge 12e side of the negative electrode layer 12 is prevented, and an utilization rate of the end portion 12f is reduced. Accordingly, expansion of the end portion 12f is prevented during charging, and damage such as cracking or peeling is prevented in a portion where the cover layer 14 is in contact with the negative electrode layer 12 or further the electrolyte layer 13 or the positive electrode layer 11.

With the configuration as illustrated in (B) of FIG. 6, the solid-state battery 1d having excellent reliability is implemented.

Although not illustrated here, in the solid-state battery 1c ((A) of FIG. 6) and the solid-state battery 1d ((B) of FIG. 6), the configuration in a cross-sectional view along the direction D2 orthogonal to the direction D3 can be the configuration described for the solid-state battery 1 ((B) of FIG. 2), the solid-state battery 1a ((A) of FIG. 3), or the solid-state battery 1b ((B) of FIG. 3).

In addition, the solid-state battery 1c ((A) of FIG. 6) and the solid-state battery 1d ((B) of FIG. 6) can be manufactured according to the examples described above with reference to (A) to (E) of FIG. 4 and (A) and (B) of FIG. 5. In this case, when manufacturing the solid-state battery 1c and the solid-state battery 1d, the layer part 32 ((C) of FIG. 4) and the layer part 34 ((E) of FIG. 4), each including the electrolyte layer 13 and the cover layer 14 on an outer surface of the electrolyte layer 13, may have a form corresponding to the configuration of the solid-state battery 1c or a form corresponding to the configuration of the solid-state battery 1d. Other procedures can be the same as those described above.

The above are merely examples. A wide variety of modifications and changes may also be made by a person skilled in the art, and the present invention is not limited to the precise configurations and applications indicated and described above, and all corresponding modifications and equivalents are deemed to be within the scope of the present invention according to the appended claims and their equivalents.

### REFERENCE SIGNS LIST

1, 1a, 1b, 1c, 1d, 1A: solid-state battery
10, 10A: battery body
10a, 10b: end surface
10c: lower surface
10d: upper surface
11: positive electrode layer
11a, 12a, 12e, 13a, 13e; edge
11d, 12b, 12d, 13b: non-facing portion
12: negative electrode layer
12c, 13c: facing portion
12f: end portion
13: electrolyte layer
14: cover layer
15: stacked structure
20: external connection terminal
30, 31, 32, 33, 34: layer part
100: lithium ion conduction
D1, D2, D3: direction
W1, W2, W3: width

1. A solid-state battery comprising:
a battery body including
a stacked structure in which a positive electrode layer and a negative electrode layer are stacked in a first direction with an electrolyte layer interposed therebetween, and
a cover layer configured to cover the stacked structure, wherein
in the battery body, an edge of the electrolyte layer in contact with the cover layer is located inward relative to an edge of the negative electrode layer in contact with the cover layer in a cross-sectional view along a second direction orthogonal to the first direction.

2. The solid-state battery according to claim 1, wherein
in the battery body, an edge of the positive electrode layer in contact with the cover layer is located inward relative to the edge of the negative electrode layer in contact with the cover layer in the cross-sectional view along the second direction.

3. The solid-state battery according to claim 1, wherein
the positive electrode layer, the negative electrode layer, and the electrolyte layer each contain a solid electrolyte, and
the cover layer contains a material different from that of the solid electrolyte.

4. The solid-state battery according to claim 1, wherein
the battery body includes a first end surface in which a part of a side surface of the positive electrode layer is exposed from the cover layer, and a second end surface that faces the first end surface and in which a part of a side surface of the negative electrode layer is exposed from the cover layer,
a third direction in which the first end surface and the second end surface face each other is orthogonal to the first direction, and
the second direction is orthogonal to the third direction.

5. The solid-state battery according to claim 1, wherein
the battery body includes a plurality of positive electrode layers, each facing the negative electrode layer with the electrolyte layer interposed therebetween, and
the positive electrode layer serves as both a lowermost layer and an uppermost layer of the stacked structure in the first direction.
